(19) United States
(12) Patent Application Publication
(10) Pub. No.: US 2006/0289644 A1
(43) Pub. Date: Dec. 28, 2006

(54) Card reader with contact springs being arranged in a double C shape

(76) Inventors: Karl-Rudolf Hopt, Rottweil (DE); Jurgen Hopt, Rottweil (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/471,194

(22) Filed: Jun. 20, 2006

(30) Foreign Application Priority Data
Jun. 23, 2005 (EP) EP 05 013 525.0

(51) Int. Cl. G06K 7/06

(52) U.S. Cl. 235/441

(57) ABSTRACT

A card reader comprises two rows of electric contacts in the form of elastically deformable contact springs for contacting the electric contact fields of a card inserted into the card reader, wherein the contact springs extend parallel to the card insertion direction and wherein each contact spring comprises a contact section projecting into the card path for contacting one of the contact fields of the card, a connecting section for connecting to a write/read device, an intermediate U-shaped joining section, and a mounting section for mounting the contact spring to the card reader housing, all being formed in one piece with the contact spring. In accordance with the invention, the U-shaped joining sections of the contact springs of both contact rows are oriented in a direction opposite to the card insertion direction.

This application claims Paris Convention priority of EP 05 013 525.0 filed 23th Jun. 2005, the complete disclosure of which is hereby incorporated by reference.

### BACKGROUND OF THE INVENTION

The present invention relates to a card reader with two rows of electric contacts in the form of elastically deformable contact springs for contacting the electric contact fields of a card which is inserted into the card reader, wherein the contact springs extend parallel to the card insertion direction, and wherein each contact spring comprises a contact section projecting into the card path for contacting one of the contact fields of the card, a connecting section for connecting to a write/read device, an intermediate U-shaped joining section and a mounting section for mounting the contact spring to the contact carrier, all being formed in one piece with the contact spring.

A card reader of this type is disclosed e.g. in EP 0 803 835 A2.

The U-shaped joining sections of the contact springs of the two contact rows of this conventional card reader are disposed to face each other. When a card is inserted into the card reader, the contact springs of the rear contact row, as viewed in the card insertion direction, which the card contacts at first during insertion, are deflected from the card path and are thereby also jolted, since the pivot point of the contact springs in the card insertion direction is ahead of the point of application of the card. In contrast thereto, the contact springs of the front contact row, as viewed in the card insertion direction, are not jolted when being deflected by the card, since in this case, the pivot point of the contact springs is behind the point of application of the card, as viewed in the card insertion direction. The contact forces and spring load of the contact springs are therefore different in the two contact rows due to jolting of the rear contact springs.

In contrast thereto, it is the object of the present invention to further develop a card reader of the above-mentioned type in such a manner that the contact forces and the spring load of the contact springs of both contact rows are the same.

### SUMMARY OF THE INVENTION

This object is achieved in accordance with the invention in that the U-shaped joing sections of the contact springs of both contact rows are oriented in a direction opposite to the card insertion direction.

With this double C shaped arrangement of the contact springs, wherein the free ends of all contact sections are oriented in the card insertion direction, the pivot point of the contact springs of both contact rows is behind the point of application of the card, as viewed in the card insertion direction. The contact sections of the contact springs of both contact rows are not jolted through insertion of a card but only resiliently deflected.

The space required by the contact springs in the transverse direction is minimized when the contact section, the U-shaped joining section, the mounting section and preferably also the connecting section are symmetrical relative to the center plane of the contact spring.

In a first, particularly preferred embodiment, the U-shaped joining section of the contact springs of at least one contact row is formed by two transversely spaced apart, parallel U-shaped arms which extend from the mounting section in a direction opposite to the card insertion direction, while the a direction opposite to the card insertion direction section extends from the mounting section between the two U-shaped arms in a direction opposite to the card insertion direction. The mounting section of the contact spring is preferably formed like a frame and the contact section of the contact spring is disposed in the frame opening. The mounting section of the contact spring moreover preferably extends to a central web of the contact carrier, which is provided between the two contact rows.

In another preferred embodiment, the U-shaped joining section of the contact springs of at least one contact row is formed by one single U-shaped arm. The mounting section is preferably formed like a frame and the contact section of the contact spring is disposed in the frame opening. The mounting section of the contact spring moreover preferably extends to a transverse web of the contact carrier which is provided in front of the contact row, as viewed in the card insertion direction.

The connecting sections of the two contact rows preferably face away from each other.

Further advantages of the invention can be extracted from the description and the drawing. The features mentioned above and below may be used individually or collectively in arbitrary combination. The embodiment shown and described is not to be understood as exhaustive enumeration but has exemplary character for describing the invention.

### BRIEF DESCRIPTION OF THE DRAWING

FIG. 1 shows a longitudinal section through the inventive card reader with contact springs being arranged in the shape of a double C;

FIG. 2 shows a top view of the inventive card reader in the region of the contact springs; and

FIGS. 3 and 4 show two different designs of contact springs of the inventive card reader.

### DESCRIPTION OF THE PREFERRED EMBODIMENT

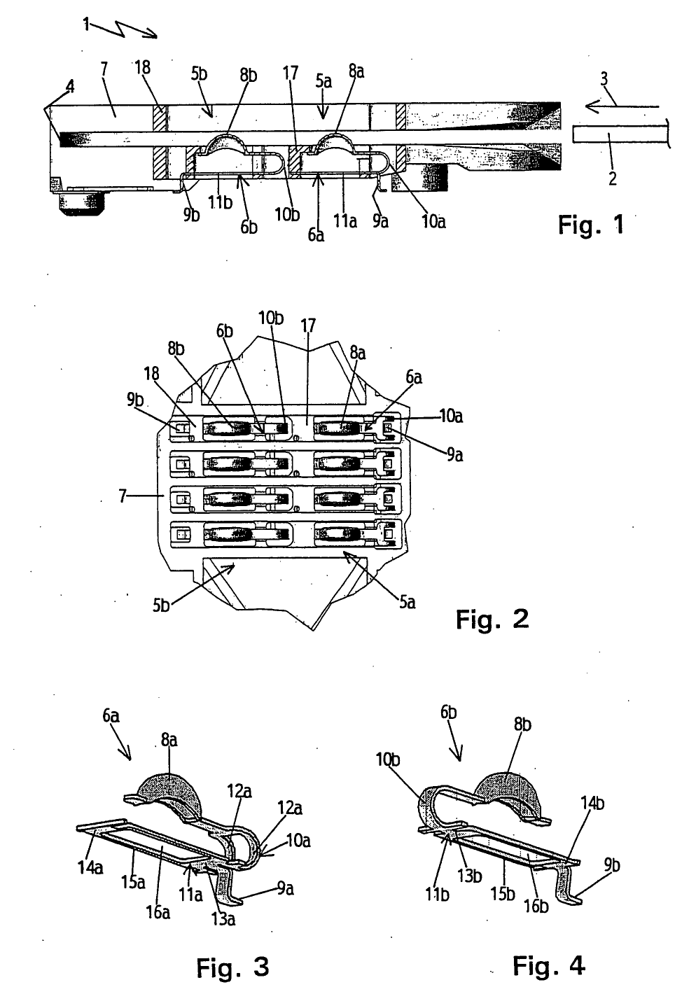

Reference numeral 1 of FIG. 1 designates a so-called push/pull card reader, wherein a user inserts a card 2 into the card reader 1 in the insertion direction 3 until the card abuts a card stop 4 in its data exchange position, and pulls it out again of the card reader 1 after data exchange. The card 2 has a microchip (not shown) for storing data, whose contacts are provided in the form of electric contact fields (not shown) on the card surface.

The card reader 1 has two rows 5a, 5b, disposed behind each other in the card insertion direction 3, of electric contacts in the form of elastically deformable contact springs 6a, 6b for contacting the electric contact fields of the card 2 inserted into the card reader 1. The contact springs 6a, 6b extend parallel to the card insertion direction 3 and are mounted to the card reader housing 7 which is an injection-molded plastic part.

Each contact spring 6a, 6b comprises a contact section 8a, 8b projecting into the card path, for contacting one of the contact fields of the card 2, a connecting section 9a, 9b for connecting a write/read device (not shown) of the card reader 1, an intermediate U-shaped joining section 10a, 10b and a mounting section 11a, 11b for mounting the contact spring 6a, 6b to the card reader housing 7, all being formed in one piece with the contact spring 6a, 6b. The contact section 8a, 8b is calotte-shaped and the connecting section 9a, 9b is formed as SMD contact.

The contact sections 8a, 8b and the U-shaped joining sections 10a, 10b of the contact springs 6a, 6b of both contact rows 5a, 5b are aligned in the same direction, i.e. the free ends of the contact sections 8a, 8b face in the card insertion direction 3, i.e. to the left-hand side in FIG. 2, and the U-shaped joining sections 10a, 10b are oriented in a direction opposite to the card insertion direction 3, i.e. are provided on the right-hand side. In other words, the contact springs 6a, 6b of both contact rows 5a, 5b are disposed in the shape of a double C, wherein the connecting sections 9a, 9b of the two contact rows 5a, 5b face away from each other. With this double C-shaped arrangement of the contact springs 6a, 6b, wherein the free ends of all contact sections 8a, 8b are oriented in the card insertion direction 3, the pivot point of the contact springs 6a, 6b of both contact rows 5a, 5b is behind the point of application of the card 2, as viewed in the card insertion direction 3. The contact sections 8a, 8b of the contact springs 6a, 6b of the two contact rows 5a, 5b are not jolted but only resiliently deflected through insertion of the card 2.

As is shown in FIG. 2, the contact section 8a, 8b, the connecting section 9a, 9b and the U-shaped joining section 10a, 10b of each contact spring 6a, 6b are in the same plane extending at a right angle to the card path and card insertion direction 3. The contact, connecting and joining sections 8a, 9a, 10a of a contact spring 6a of one contact row 5a and the contact, connecting and joining sections 8b, 9b, 10b of a contact spring 6b of the other contact row 5b are thereby in the same plane.

As is shown in FIG. 3, the U-shaped joining section 10a of the contact springs 6a of the rear contact row 5a, as viewed in the card insertion direction 3, is formed by two parallel U-shaped arms 12a which are spaced apart in a transverse direction and extend from a transverse web 13a of the mounting section 11a in a direction opposite to the card insertion direction 3. The connecting section 9a also extends from this transverse web 13a between the two arms 12a in a direction opposite to the card insertion direction 3, i.e. the connecting section 9a is provided on the contact spring 6a on the side of the U-shaped joining section 10a. The mounting section 11a is formed like a frame and comprises, in addition to the transverse web 13a, also the transverse web 14a and the two side legs 15a, wherein the contact section 8a is above the frame opening 16a or, in the top view of FIG. 2, within the frame opening 16a. The mounting section 11a whose transverse web 14a extends to a central web 17 (FIG. 2) of the card reader housing 7 provided between the two contact rows 5a, 5b, is an insert which is completely surrounded by injection-molded plastic material during production of the card reader housing 7. The contact section 8a, the connecting section 9a, the U-shaped joing section 10a and the mounting section 11a are symmetrical relative to the center plane of the contact spring 6a, such that no transverse forces can be generated in the contact spring 6a and the transverse dimension of the contact spring 6a is minimized.

As is shown in FIG. 4, the U-shaped joing section 10b of the contact springs 6b of the front contact row 5b, as viewed in the card insertion direction 3, is formed by one single U-shaped arm. The mounting section 11b has the shape of a frame comprising the two transverse webs 13b, 14b and the two side legs 15b, wherein the contact section 8b is above the frame opening 16b or within the frame opening 16b as shown in the top view of FIG. 2. The U-shaped connecting section 10b extends from the transverse web 13b of the mounting section 11b in a direction opposite to the card insertion direction 3, while the connecting section 9b extends from the transverse web 14b in the card insertion direction 3, i.e. is provided on the contact spring 6b on the other side of the U-shaped connecting section 10b. The mounting section 11b whose transverse web 14b extends to a further transverse web 18 of the card reader housing 7 is an insert which is completely surrounded by injection-molded plastic material during production of the card reader housing 7. The contact section 8b, the connecting section 9b, the U-shaped joining section 10b and the mounting section 11b are symmetrical relative to the center plane of the contact spring 6b such that no transverse forces can be generated in the contact spring 6b and the transverse dimension of the contact spring 6b is minimized.

We claim:

1. Card reader comprising two rows of electric contacts in the form of elastically deformable contact springs for contacting electric contact fields of a card inserted into the card reader, wherein the contact springs extend parallel to a card insertion direction and wherein each contact spring comprises a contact section projecting into a card path for contacting one of the contact fields of the card, a connecting section for connecting to a write/read device, an intermediate U-shaped joining section and a mounting section for mounting the contact spring to the card reader housing, all being formed in one piece with the contact spring, wherein the U-shaped joining sections of the contact springs of both contact rows are oriented in a direction opposite to the card insertion direction.

2. Card reader according to claim 1, wherein the contact section, the U-shaped joining section and the mounting section are symmetrical relative to the center plane of the contact spring.

3. Card reader according to claim 2, wherein the connecting section is also symmetrical relative to the center plane of the contact spring.

4. Card reader according to claim 1, wherein the U-shaped joining section of the contact springs of at least one contact row is formed by two parallel U-shaped arms which are spaced apart in a transverse direction and extend from the mounting section in a direction opposite to the card insertion direction, and the connecting section extends from the mounting section between the two U-shaped arms in a direction opposite to the card insertion direction.

5. Card reader according to claim 4, wherein the mounting section of the contact spring has the shape of a frame and the contact section of the contact spring is in the frame opening.

6. Card reader according to claim 4, wherein the mounting section of the contact spring extends to a central web of the card reader housing provided between the two contact rows.

7. Card reader according to claim 1, wherein the U-shaped joining section of the contact springs of at least one contact row is formed by one single U-shaped arm.

8. Card reader according to claim 7, wherein the mounting section has the shape of a frame and the contact section of the contact spring is in the frame opening.

9. Card reader according to claim 7, wherein the mounting section of the contact spring extends to a transverse web of the card reader housing, provided in front of the contact row, as viewed in the card insertion direction.

10. Card reader according to claim 1, wherein the connecting sections of the two contact rows face away from each other.

11. Card reader according to claim 1, wherein the connecting sections of the two contact rows are SMD contacts.

12. Card reader according to claim 3, wherein the U-shaped joining section of the contact springs of at least one contact row is formed by two parallel U-shaped arms which are spaced apart in a transverse direction and extend from the mounting section in a direction opposite to the card insertion direction, and the connecting section extends from the mounting section between the two U-shaped arms in a direction opposite to the card insertion direction, wherein the mounting section of the contact spring has the shape of a frame and the contact section of the contact spring is in the frame opening, and wherein the mounting section of the contact spring extends to a central web of the card reader housing provided between the two contact rows.

13. Card reader according to claim 12, wherein the U-shaped joining section of the contact springs of at least one contact row is formed by one single U-shaped arm, wherein the mounting section has the shape of a frame and the contact section of the contact spring is in the frame opening, and wherein the mounting section of the contact spring extends to a transverse web of the card reader housing, provided in front of the contact row, as viewed in the card insertion direction.

14. Card reader according to claim 13, wherein the connecting sections of the two contact rows face away from each other.
